(19) United States
(12) Patent Application Publication
(10) Pub. No.: US 2002/0018048 A1
(43) Pub. Date: Feb. 14, 2002

(54) Z-AXIS POINTING STICK WITH ESD PROTECTION

(76) Inventors: LEWIS L. SEFFERNICK, DECATUR, IN (US); ROBERT M. VANDENBOOM, MARKLE, IN (US); NORMAN C. WEINGART, ELKHART, IN (US)

Correspondence Address: MICHAEL W STARKWEATHER, CTS CORPORATION, 905 NORTH WEST BOULEVARD, ELKART, IN, 46514

(21) Appl. No.: 08/794,703

(22) Filed: Feb. 4, 1997

(51) Int. Cl. G08B 21/00

(52) U.S. Cl. 345/161; 345/160; 340/540

(57) ABSTRACT

A pointing device for controlling the positioning, movement and operation of a cursor on a display screen. Specifically, there is a pointing stick that both directs a cursor and acts as the activation button for selecting items on the display screen by tapping on the pointing stick instead of clicking on a mouse button. Additionally, there is a pointing stick that is both ESD (electrostatic discharge) and seffernick force insensitive.

This application is related to copending U.S. application Ser. No. 08/756,202, entitled Z-axis sensing pointing stick with base as strain concentrator, filed Nov. 25, 1996, and copending U.S. application Ser. No. 08/717,517, entitled Collar Mounted Pointing Stick, filed Sep. 23, 1996. Both applications being assigned to the current assignee of this application and are herein incorporated by reference in their entirety.

### BACKGROUND OF THE PREFERRED EMBODIMENT(S)

1. Field of the Preferred Embodiment(s)

This invention generally relates to a pointing device for controlling the positioning, movement and operation of a cursor on a display screen. Specifically, there is a pointing stick that both directs a cursor and acts as the activation button for selecting items on the display screen by tapping on the pointing stick instead of clicking on a mouse button. Additionally, there is a pointing stick that is ESD (electrostatic discharge) insensitive.

2. Description of the Related Art

Various devices are well known for controlling cursor movement over a computer display screen of a computer and for signaling a choice of computer command identified by the position of the cursor on the display screen menu. One such device is a “mouse” which has a ball on its underside rolled over a horizontal surface, with the x- and y-axis components of movement being sensed and transmitted through a connecting cable to a serial input port of the computer. The signal to the computer is varied by the amount and direction of movement of the mouse ball, and causes the cursor on the display screen to have a corresponding movement. One or two “mouse” or “click” buttons located on the top of the mouse at the forward end permit the computer operator to enter a selection or other command to the computer (the command typically being shown by the position of the cursor on a displayed menu) upon pressing one or the other or both buttons, depending upon the software associated with the device. Such a device, which is separate from the computer console and keyboard and requires a connection to a computer port, requires a flat, horizontal surface, and for operation of the mouse, the computer operator must completely remove one hand from the computer keyboard.

Another cursor controlling and signaling mechanism is a “joystick” which like the mouse is completely separated from the computer console and keyboard. The joystick is typically an elongated stick that extends upwardly from a base connected to the computer console by means of a cable. The joystick is operated by tilting the upstanding stick in various directions to cause the cursor or other display element to move in a direction and usually at a speed corresponding to the direction and pressure exerted on the stick by the computer operator. The operation of a joystick, however, frequently requires that both hands be removed from the computer keyboard, one hand to hold the base while the other manipulates the joystick. A “click” button is usually located on the joystick. Although a mouse or a joystick can be used with a portable “laptop” or “notebook” size computers, such devices are cumbersome, must be carried separately and connected to the computer before use, and are not suitable for operation during travel.

Still, another type of cursor controlling device is a “trackball.” This device, which in essence is an inverted mouse, includes a rotatable ball mounted within a housing. The ball is rotated by a finger, thumb or palm of the computer operator, and the x- and y-components of movement are sensed and input into the computer to cause corresponding movement of the cursor across the display screen. “Mouse” or “click” buttons are usually located on the trackball housing, although with some models the selection signal is input by pressing the “enter” key on the standard keyboard. This type of pointing device has been found useful with portable computers because it can be temporarily affixed to one side of the computer case for manipulation by one hand of the computer operator. However, although trackball devices can be removably attached to the computer case, they still require attachment before use and removal after use. It is also noted that some trackballs are built into the computer keyboard. Nonetheless, these trackballs require a separate set of “click” buttons for selection of items on the display monitor.

Manufacturers of portable laptop computers, recognizing the need for placing the cursor controlling device in a permanent and more convenient location, installed a small stubby, button-like joystick centrally around the keys of the computer keyboard, specifically at the juncture of the “g,” “h” and “b” keys of the standard “QWERTY” keyboard. The joystick, also known as a pointing stick, was sensitive to lateral pressure, the amount and direction of which were sensed and input into the computer to cause movement of the cursor, and the speed and direction of cursor movement corresponded to the amount and direction of pressure on the joystick. However, the manufacturer has to provide upwardly extending “mouse” or “click” buttons somewhere on the computer.

Despite the advantages of each type of cursor control, none have allowed the user to both control the cursor movement and select items on the display using exclusively a pointing stick device. Additionally, no prior art allows the user this dual control by using only one finger while allowing the remaining fingers to reside on the home row of the standard keyboard.

Description of Related Art

Examples of patents related to the present invention are as follows, wherein each patent is herein incorporated by reference for related and supporting teachings:

U.S. Pat. No. Re. 35,016, is a three-axis force measurement stylus.

U.S. Pat. No. 5,489,900, is a strain sensitive columnar transducer for a data entry keyboard contains a column upstanding from the keyboard.

U.S. Pat. No. 5,521,596, is a sensor device placed either underneath a key cap or a key on a keyboard or between two keys on a keyboard so that cursor movement may be carried out from the keyboard itself.

U.S. Pat. No. 5,473,347, is a computer pointing device for controlling the positioning, movement and operation of a cursor on the display screen of a computer.

U.S. Pat. No. 5,407,285, is an apparatus for use in a computer keyboard for cursor control is disclosed.

U.S. Pat. No. 5,325,081, is a supported strain gauge and joy stick assembly and method of making.

U.S. Pat. No. 5,263,375, is a contact detector using resistance elements and its application.

U.S. Pat. No. 4,969,366, is a moment detector using resistance elements.

U.S. Pat. No. 4,967,605, is a detector for force and acceleration using resistance elements.

U.S. Pat. No. 4,905,523, is a force detector and moment detector using resistance elements.

U.S. Pat. No. 4,876,524, is an isometric control device or the like of the type having an elastic beam and strain gauges attached to the surface of the beam characterized by at least a first group of three strain gages each having an operative axis thereof inclined with a single predetermined angle with respect to the main axis of the beam, and the strain gauges disposed at a first predetermined level along the beam.

U.S. Pat. No. 4,680,577, is a multipurpose key switch for controlling cursor movement on a CRT display and for character entry includes a key cap that moves laterally to provide cursor control and that moves vertically for character entry.

The foregoing patents reflect the state of the art of which the applicant is aware and are tendered with the view toward discharging applicants' acknowledged duty of candor in disclosing information that may be pertinent in the examination of this application. It is respectfully stipulated, however, that none of these patents teach or render obvious, singly or when considered in combination, applicants' claimed invention.

Problems with the Prior Art

There are several problems that exist with the prior art that are addressed by the preferred embodiment. One problem for pointing stick developers is to deal with seffernick forces. Seffernick forces are those forces that are applied to a supporting structure, a keyboard for example, that are translated to the pointing stick. For example, typing on a keyboard can generate seffernick forces. In that case, the pointing stick is so sensitive that a user would be activating the pointing stick operation unintentionally. The sensitive electronics on the pointing stick would sense the deformation of the keyboard support surfaces and translate that into deformation of its own support surface and mistakenly generate control signals. Thus, seffernick forces are those forces that are translated from a support structure through the body of the pointing stick and to the electronic components of the pointing stick sufficient to generate unintentional control signals.

Another problem with the prior art pointing sticks is the lack of ESD (electrostatic discharge) protection. Users of keyboards, for example, often build up static electricity that is discharged to the sensitive electronics on the pointing device. If the pointing device receives ESD energy the sensitive electronics of not only the pointing stick but also the keyboard or even the associated computer components could be damages.

This and other problems will be solved by the preferred embodiments of the invention. A review of the specification, drawings, and claims will more clearly teach a skilled artisan of other problems that are solved by the preferred embodiments.

### SUMMARY OF THE PREFERRED EMBODIMENT(S)

It is a feature of the invention to provide a pointing stick for controlling the positioning, movement and operation of a cursor on the display screen.

It is another feature of the invention to provide a pointing stick that has ESD protection. Specifically, there is a housing structure that is grounded and surrounds key portions of the pointing stick to ground any ESD events away from any electronics on the pointing stick.

A further feature of the invention is to provide a pointing stick assembly using resistor based strain gages mounted on the sides of the shaft of the pointing stick. Wherein, the strain gages are for sensing when either the stick or base is being bent. Upon bending, strain is created on the resistor based strain gages. Wherein, the strain gages are coupled to circuitry that will produce signals in response to the strain on the gages. The resulting signals are used to either control the movement of the cursor around the display screen, or to do what is commonly called “clicking” a mouse button for selection of items or dragging of items on the display screen.

Yet, a further feature of the invention is to provide a device that has a pointing stick extending through the base so that the side mounted strain gages extend through the bendable base. Thus, when the stick is pushed downward along the z-axis, the base will exert pressure on all strain gages.

A further feature of the invention is to provide an easy method or design for coupling the electrical traces located on the flexible cable to the resistor based strain gages.

An additional feature of the invention is to provide a mountable pointing stick that is protected from seffernick forces. Specifically, there is a protective housing that isolates the post assembly and is not mechanically fixed to the post assembly. Additionally, the housing does not deform the base and electrical parts of the pointing stick when the housing itself is being deformed to some degree or being jarred by seffernick forces. Specifically, there is a post base and electrical trace film that are bonded together forming the electromechanical working portion of the invention. Additionally, there is a housing component of the invention, which is integrally mounted to a keyboard base, and protects the post assembly from stresses associated with mounting to the keyboard.

The invention resides not in any one of these features per se, but rather in the particular combination of all of them herein disclosed and claimed. Those skilled in the art will appreciate that the conception, upon which this disclosure is based, may readily be utilized as a basis for the designing of other structures, methods and systems for carrying out the several purposes of the present invention. Further, the abstract is neither intended to define the invention of the application, which is measured by the claims, neither is it intended to be limiting as to the scope of the invention in any way.

### BRIEF DESCRIPTION OF THE DRAWINGS

These and other features of the invention can best be understood by the following description of the accompanying drawings as follows:

FIG. 1 is a perspective view of a related art pointing stick.

FIG. 2 is a perspective view of the pointing stick in FIG. 1 as placed between keys of a keyboard.

FIG. 3 is a perspective view of the preferred embodiment.

FIG. 4 is a cross sectional view of FIG. 3.

FIG. 5 is a cross sectional view of FIG. 3 illustrating a close up view of the operational assembly.

FIG. 6 is an electrical schematic of a bridge circuit incorporating the strain sensitive elements.

FIG. 7 is an illustration of the pointing stick as used on a keyboard operated computer system.

It is noted that the drawings of the invention are not to scale. The drawings are merely schematic representations, not intended to portray specific parameters of the invention. The drawings are intended to depict only typical embodiments of the invention, and therefore should not be considered as limiting the scope of the invention. The invention will be described with additional specificity and detail through the accompanying drawings.

### DETAILED DESCRIPTION OF THE PREFERRED EMBODIMENT

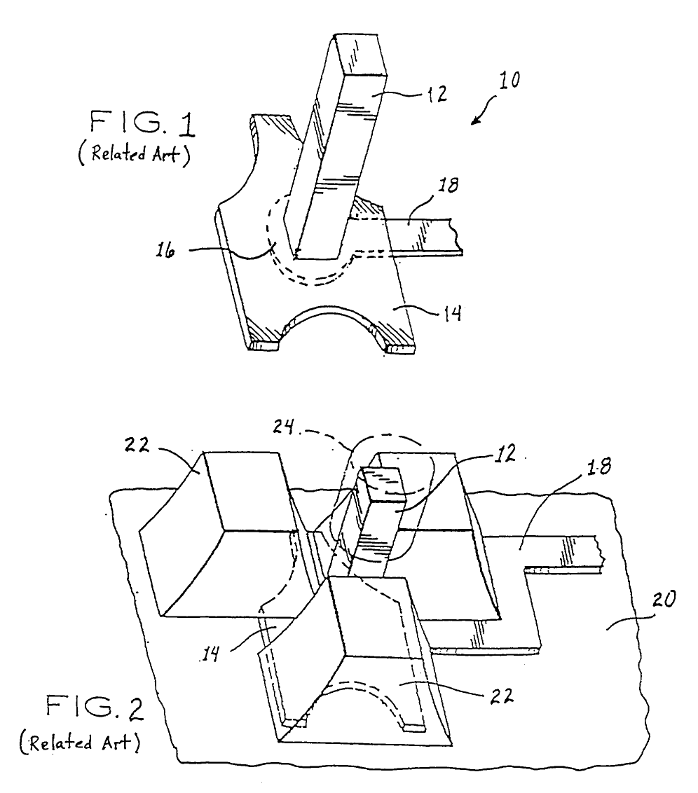

Referring to both FIGS. 1 and 2, there is a related art pointing stick 10 that can be used to control the movement of a curser on a computer screen (not shown). In particular, the pointing stick 10 is made up of a stick 12 (or shaft), a substrate 14 for supporting the stick 12 (also referred to as a shaft or post), and a cavity 16 formed in the base 14 for placement of a flexible cable 18 that is electrically connected to four strain gages (not shown) located on the sides of the stick 12. The stick may be made of alumina ceramic material. Typically, the cable 18 may be made of polyamide material containing electrical traces thereon. The pointing stick 10 is typically positioned on the supporting base 20 and between the B, G and H keys 22 of a typing keyboard. Typically, the pointing stick has a rubber-like cap 24 positioned over the top of stick 12 to increase the ease of operation. The cap is designed to enable the operator to control the cursor with a single finger positioned on top of it and pushing in desired cursor direction. The finger pressure causes strain in the stick that is sensed by the sensitive gages (not shown). The base 14, made of epoxy glass, FR4, or molded polycarbonate material, to name a few, will have some impact upon the strain gages because of the increased flexibility of the base around the gages.

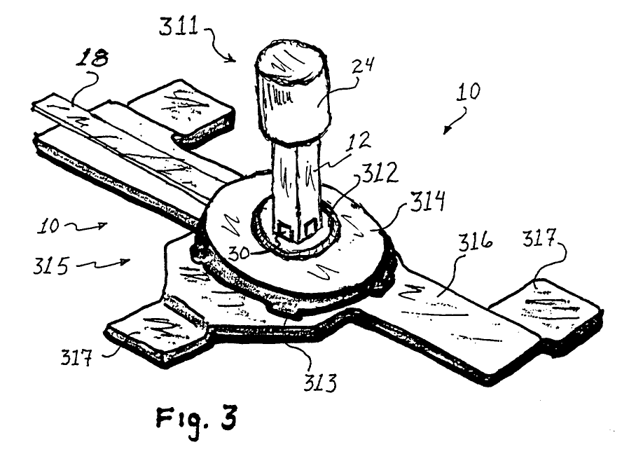

Referring to FIG. 3, there is a perspective view of the preferred embodiment of the invention. Specifically, there is pointing stick 10 having a post assembly 311. The post assembly 311 is made up of the ceramic post 12, a plastic base 312 for mounting the post therein, and the flexible cable 18 for routing signals from the post 12 to signal conditioning circuitry (not shown). Of course, the post assembly components are fixedly attached to each other to form a unitary body. The post 12 has strain gages 30 (electrical circuit) mounted thereon, and a plastic cap 24 positioned over the post for use by a keyboard user to direct the movement of a cursor on a computer display. There is also a housing 315, which is made up of a cover 314 and bracket 316. The cover includes a mounting tab 313 for attaching the cover to a bracket 316. The bracket 316 serves as a base for mounting the whole pointing stick assembly 10 onto a keyboard 20 by attaching support pads 317 thereto.

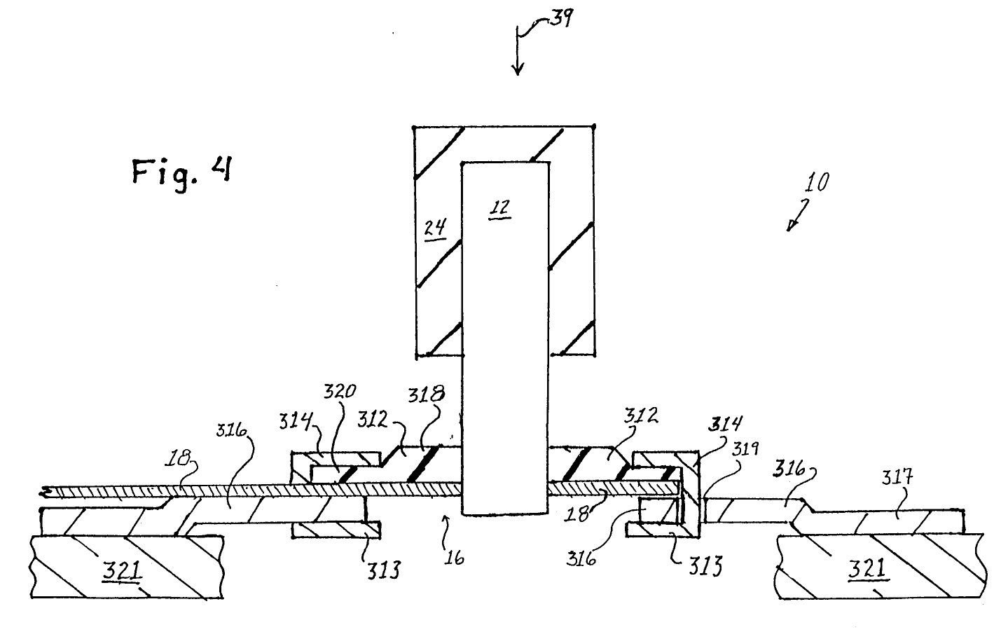

Referring to FIG. 4, there is a cross sectional view of FIG. 3. Specifically, the base 312 has a collar 318 that protrudes from the cover 314, and a second section 320 that fits under cover 314. Bracket 316 has holes 319 therein for inserting tabs 313 therethrough, which are thereby bent upon being inserted into the position illustrated. Bracket 316 is typically mounted upon a structure 321, like a keyboard, via pads 317.

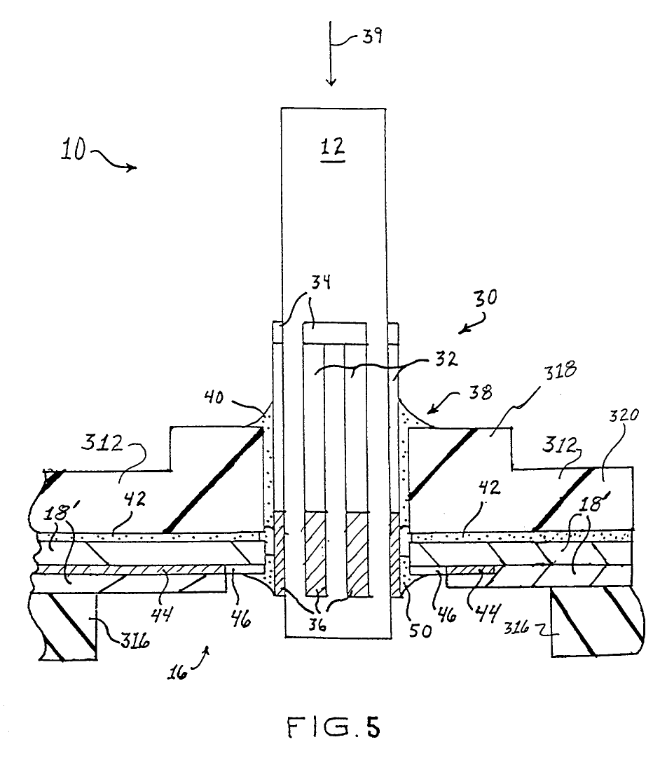

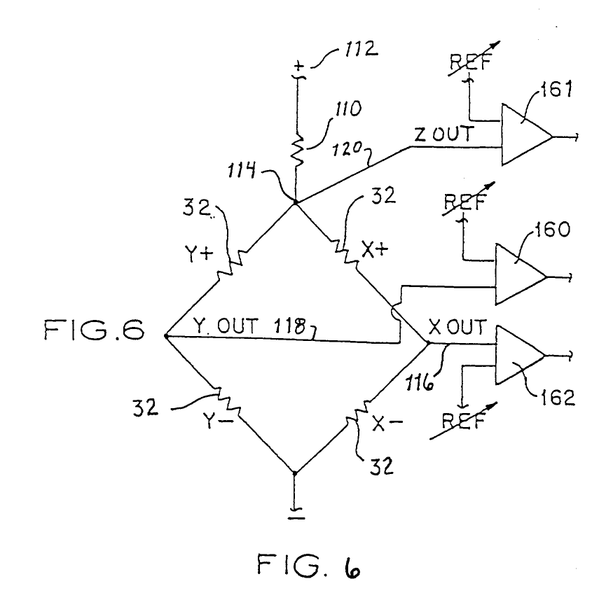

Referring to FIG. 5, there is a cross-sectional view of FIG. 3 taken along the edge of cable 18 and along the one side of the stick 12. In particular, the following additional elements are illustrated: Strain gages 30 are mounted on the sides of the stick 12 and are made of pressure sensitive strips 32, for electrically changing the resistance of the material in response to the amount of strain applied thereto, a conductive contact bridge 34 for electrically connecting the two strips 32, and conductive contact pads 36 for making electrical contact to signal conditioning electronic circuitry (not shown) via flexible cable 18. A suitable material for the cable 18 is a polyimide film, also known as a printed flex cables made by Fujikura America. The cable 18 has electrical traces 44 and input/output (I/O) pads 46 mounted between the two insulative layers 18′. The insulative film layers insulate the traces from the bracket 316. The stick 12 extends through hole 38 in a z-axis direction 39, and is held in place by an adhesive bond epoxy 40. For example, a cyanoacrylate adhesive material is also suitable for bonding. Cable 18 is positioned within cavity 16. Contact pads 36 are bonded to I/O pads 46 by any suitable bond material 50, like tin-lead solder. It is noted that only the post assembly is bonded together and it is not fixedly attached to the housing 315.

The pointing stick 10 can be assembled as follows: The first step usually involves either the screening of resistive thick film or the sputtering of resistive thin film material on the sides of stick 12. The screened on material forms the strain gages 30. The second step often involves the placement of the stick 12 into the substrate or plastic base 312 (or base). Thereafter, usually flexible cable 18 is attached to connect the strain gages 30 to signal conditioning circuitry (not shown). Next, the solder material may be placed around the stick 12 to attach all eight 1/0 pads 46 to all eight contact pads 36, two on each side of the stick 12. Next, a certain amount of bonding material 40 may be applied onto the cable to secure it to the base 312. Finally, the whole assembly is cured to harden the bonding materials. Finally, the now completed post assembly 311 is placed onto the bracket 316 and the cover 314 is thereby attached by tabs 313, thus holding the post assembly therein.

In reference to FIG. 6, there is an electrical schematic of a bridge circuit incorporating the strain sensitive elements. Specifically, this circuit is an example of how the z-axis pointing stick can be arranged to interface with the electronics (not shown). The strain sensitive resistors 32 on opposing sides of the stick 12 are configured in two half bridge circuits, resistors 32 Y+ and 32 Y− form a first half bridge, and resistors 32 X+ and 32 X− form the second half bridge. A fixed resistor 110 is connected between the supply voltage 112 of the system and node 114. The X, Y, and Z OUT outputs, 116, 118, and 120 respectively, are amplified by the three differential amplifiers 160, 161, and 162. Each amplifier has a variable reference voltage input. These reference voltages are calibrated to set the output to zero when no force is applied to the stick 12. The X and Y axis outputs 116 and 118 are developed when an X or Y directional force is applied to the stick 12. For example, when a force is applied in the X direction, the X− and X+ strain sensitive resistors change resistance in opposite directions and cause an output change. The same is true for the Y-axis. A Z-axis output is developed when a Z-axis force is applied to the top of the stick 12. Force in the Z-axis causes all resistors 32 on the stick 12 to change in a negative direction. This change lowers the total impedance of the two half bridges. The lower bridge impedance causes a voltage change in the Z output 120 since the series resistor 110 is fixed.

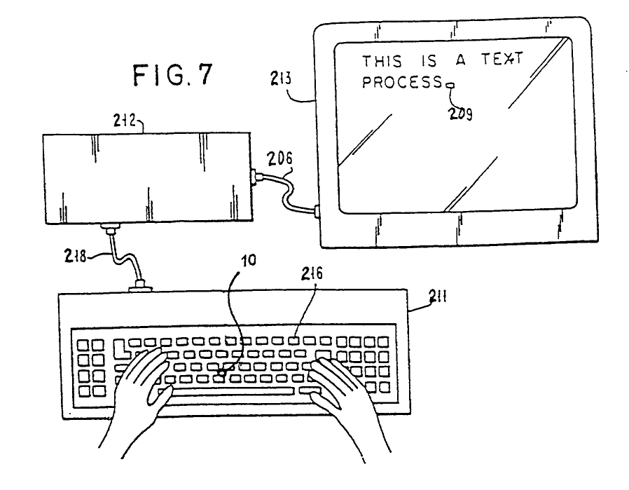

Referring to FIG. 7, there is shown a keyboard operated computer system. The system includes a keyboard 211 implemented by this invention and connected to a computer 212. The data entry from the keyboard 211 is displayed on a computer display or monitor 213 during the normal course of operation of an application program. The keyboard has a layout of keys 216 that is an industry standard. The keyboard is shown to have an output cable 218 coupled to the computer 212. The computer is coupled to the monitor via connecting cable 206. A cursor 209 is displayed on the computer monitor 213. The pointing stick 10 is located in the middle of the keyboard 211.

Remarks About the Preferred Embodiment

One of ordinary skill in the arts of strain gages and ceramic materials, and more particularly the art of designing pointing sticks with strain gages on the sides, will realize many advantages from using the preferred embodiment. In particular, strain gages are devices that sense the amount and of applied pressure placed upon the pointing stick. The sensed pressure creates electrical output signals used to direct the cursor on a display device. Thus, the side mounted strain gages enables control of both the directions of the cursor movement and the selection of items on the display device by tapping the pointing stick like the clicking of a mouse button. Of course, a skilled artisan will realize that the base 312 may have some flexure in a downward direction during the application of tapping force. Specifically, the flexing of the base 312 will cause some force to be applied to the sensor from the top portion of the walls of the hole 38.

Additionally, a skilled artisan will understand that the strain gages may be made of thick films piezo-resistive material, which are applied using known screen techniques.

It is further noted that a skilled artisan would realize that the pointing stick 10 is capable of now performing selection and dragging of icons on a monitor in addition to double clicking for selection of an item. In this operation, the user would hold down the pointing stick 10 while exerting additional force in the X-Y plane for controlling the direction of the icon being dragged. All of these functions are now capable of being performed with a single finger while the remaining fingers are inactively located on a homerow of the keyboard. The homerow being the keys marked “a, s, d, f, j, k, l, and ;” as typically referred to in typing manuals.

It is noted that there are two basic assemblies to the present pointing stick 10 design. Namely, the housing 315 and the post assembly 311, which are not permanently fixed to each other. The advantage of having two separate loose parts is that the housing protects the post assembly from seffernick forces resulting from keyboard usage. In other words, a keyboard user could pound upon the keyboard and cause some deformation of the housing 315, but the force sensitive electronics on the post assembly 311 would not be deformed or sense the seffernick forces enough to generate spurious signals. Although the housing 315 and assembly 311 are tightly positioned to each other, there is enough room for the assembly to move independent of the housing. This independent movement between these two parts provides for the insensitivity to seffernick forces.

It is noted that collar 318 serves to create and focus the strain onto the strain gages located on the flexible post 12. Thus, when a z-axis force 39 is applied thereto, collar 318 will press against the post 12 generally on all four sides.

It is further noted that mounting pabs 317 lift or isolate the remaining portion of the pointing stick off of the supporting structure 321, like is a keyboard 20. The combination of the lifting of the main portion of the pointing stick 10 off of the keyboard and the loose fitting of the post assembly 311 within the housing 315 also server to stop the effect of seffernick forces upon the post assembly.

It is noted that both the cover and bracket may be made of an electrically conductive material, preferably metal. When the housing is made of metal it will act as a low impedance path to ground for any potential electrostatic discharge (ESD) events. In other words, the metal housing 315 will protect the electrical circuitry, via. the strain gages, from any potential ESD. Of course one skilled in the art will realize that the pointing stick 10 would have to be coupled to a ground potential.

One of ordinary skill in the arts of strain gages will realize the collar 318 will increase or focus the strain created from movement of the shaft 12, along the length of the strain gages. In particular, the shorter section 320 would not provide a large enough surface area contact on the strain gages to generate large enough signals for detection.

Variations of the Preferred Embodiment(s)

One of ordinary skill in the art of making pointing stick will realize that there are many different ways of accomplishing the preferred embodiment. For example, it is contemplated to make the pointing stick 12 and substrate 312 out of any suitable material, like ceramic material, plastics, epoxy resin, or metals etc. Additionally, although bonding compound 40 is illustrated to be placed between the substrate 312 and the stick 12, it may not be required when the hole 38 fits securely around the stick 12. This is equally true for material 50 if the flexible cable 18 fits securely around stick 12, in which only a small amount of solder may be needed to enhance electrical contact therebetween.

Even though, the embodiment discusses the use of strain gages on all four sides of the stick 12, it is contemplated to use only two sides of the stick 12 for sensing only either the positive or negative strain on the bending of the stick for creating the resulting control signals.

Similarly, even though the embodiment discusses the use of a cursor on a monitor, one skilled in the computer arts would realize that any item that can be moved around by the typical mouse may be controlled by the preferred embodiment. For example, pointing arrows, icon selection items, air planes, boats, cats, pictures of atoms, all could have their movements controlled.

Although, the base 312 is illustrated in FIG. 5 as having a large step between the collar 318 and the second portion 320, it is contemplated to have many designs for the transition. For example, it is possible to have a ramping, or even to have the second section 320 to be the same as the collar 318.

Additionally, although it is illustrated that the flexible cable 18 separates the base 312 from contact with the bracket 316, it is contemplated to form a groove in base 312 to fit a smaller sized cable around the post 12 so that the base 312 would then act as a supporting surface to contact bracket 316.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. An electrical device, comprising:
a) signal means for receiving applied forces and generating signals representative of the applied forces; and
b) protection means, having at least a portion of the signal means mounted therein, for protecting the signal means from both ESD and seffernick forces.

2. The electrical device of claim 1, wherein the signal means comprises:
a) a shaft having a longitudinal length oriented along a first axis;
b) a base having the shaft mounted therein; and
c) a sensor, mounted on the shaft, for conditioning an output signal indicative of a force exerted along the first axis.

3. The electrical device of claim 2, further comprising:
an input trace positioned under the base and abutting to the sensor, for coupling the sensor to a voltage source; and
an output trace positioned under the base and coupled to the sensor, for outputing signals indicative of the direction that the shaft is being forced.

4. The electrical device of claim 3, further comprising:
a flexible cable for supporting the input and output traces that are mounted under the base.

5. The electrical device of claim 2, wherein the protection means comprises:
a) a cover; and
b) a bracket, coupled to the cover to secure the shaft, base, and electrical trace between the bracket and cover.
